(19) United States
(12) Patent Application Publication
(10) Pub. No.: US 2026/0361253 A1
(43) Pub. Date: Nov. 12, 2026

(54) Motor Driver and Motor Driving System

(71) Applicant: Siemens Aktiengesellschaft, München (DE)

(72) Inventors: Hua Liao, Beijing (CN); Jun Ping Zhang, Nanjing (CN)

(73) Assignee: Siemens Aktiengesellschaft, München (DE)

(21) Appl. No.: 19/125,657

(22) PCT Filed: Oct. 31, 2022
(86) PCT No.: PCT/CN2022/128631

§ 371 Date: Apr. 29, 2025

(51) Int. Cl. H02P 27/06; H02P 3/18; H02P 29/02

(52) U.S. Cl. CPC H02P 27/06; H02P 3/18; H02P 29/02; H02P 2201/03

(57) ABSTRACT

A motor driver may include: an input connected to a three-phase grid; an output connected to a motor; a rectifier circuit; a DC link circuit; and an inverter circuit. The rectifier circuit comprises two rectifier bridges. The inverter circuit comprises three DC/AC conversion branch circuits in parallel between output terminals of the DC link circuit. Each DC/AC conversion branch circuit comprises two switch devices. The DC link circuit is connected between the rectifier circuit and the inverter circuit and includes a capacitor, a seventh switch, a freewheeling diode, and an inductor. The ends of the capacitor are connected to output terminals of the rectifier circuit.

### CROSS-REFERENCE TO RELATED APPLICATIONS

This application is a U.S. National Stage Application of International Application No. PCT/CN2022/128631 filed Oct. 31, 2022, which designates the United States of America, the contents of which are hereby incorporated by reference in their entirety.

### TECHNICAL FIELD

The present disclosure relates to circuits. Various embodiments of the teachings herein include motor drivers and motor driving systems and/or methods.

### BACKGROUND

Voltage frequency converters (VFC) are widely used in motor driving and servo industries. In most cases, a capacitor is used as a power decoupling device in a DC link circuit. During motor braking, regeneration energy is applied to the capacitor of the DC link circuit, causing a rise of a DC voltage. If the voltage continuously rises and exceeds an allowable operating voltage, the DC capacitor may be damaged. Usually, a braking resistor is used to consume the regeneration energy to prevent damage to components caused by overvoltage, which, however, causes other problems such as heat dissipation and a large volume.

FIG. 1 is a topology of a motor driver 10 in the prior art. Ua, Ub, and Uc are three phases of a grid. Two single-phase diode rectifier bridges are used at an input terminal. One leg from each rectifier bridges share one grid phase to support a 1AC or 3AC power supply input. An intelligent power module (IPM) is used in a DC/AC converter to realize a compact design. A large braking resistor R1 is connected to the DC link through a power switch T7. If a DC voltage rises to a limitation, the power switch T7 will be activated, and R1 will absorbs the overvoltage. A freewheeling diode D9 is added to eliminate a transient overvoltage caused by a stray inductance of the braking resistor R1.

Since the braking resistor R1 needs to dissipate the regeneration energy of the motor, the braking resistor needs to be configured with a relatively high power capacity and a relatively large volume. In addition, since the braking resistor is usually tailor-made, the cost is rather expensive. Above all, since a high dissipation power will generate a high temperature inside the resistor, even up to hundreds of degrees Celsius, a heat sink and a structure design of the entire system face great challenges.

### SUMMARY

This summary is not an exhaustive overview of the teachings of the present disclosure. It is not intended to determine key or important parts of the teachings, nor is it intended to limit the scope of the present disclosure. The purpose is merely to present some concepts in a simplified form as a prelude to the more detailed description that is discussed later. In view of the above, some embodiments of the present disclosure include a motor driver capable of eliminating overvoltage damage.

For example, some embodiments include a motor driver (20), wherein an input terminal of the motor driver (20) is connected to a three-phase grid (Ua, Ub, Uc), an output terminal of the motor driver (20) is connected to a motor (M), the motor driver (20) comprises a rectifier circuit (210), a DC link circuit (220), and an inverter circuit (230), the rectifier circuit (210) comprises a first rectifier bridge (2101) and a second rectifier bridge (2102), the inverter circuit (230) comprises a first DC/AC conversion branch circuit (2301), a second DC/AC conversion branch circuit (2302), and a third DC/AC conversion branch circuit (2303) arranged in parallel between a positive output terminal and a negative output terminal of the DC link circuit (220), the first DC/AC conversion branch circuit (2301) comprises a first switch device (T1) and a second switch device (T2), the second DC/AC conversion branch circuit (2302) comprises a third switch device (T3) and a fourth switch device (T4), and the third DC/AC conversion branch circuit (2303) comprises a fifth switch device (T5) and a sixth switch device (T6), wherein the DC link circuit (220) is connected between the rectifier circuit (210) and the inverter circuit (230), the DC link circuit (220) comprises a capacitor (C1), a seventh switch device (T7), a freewheeling diode (D9), and an inductor (L1), a first end and a second end of the capacitor (C1) are respectively connected to a positive output terminal and a negative output terminal of the rectifier circuit (210), a collector of the seventh switch device (T7) is connected to the first end of the capacitor (C1), an emitter of the seventh switch device (T7) is connected to a negative electrode of the freewheeling diode (D9), a positive electrode of the freewheeling diode (D9) is connected to the second end of the capacitor (C1), a first end of the inductor (L1) is connected to a midpoint between the seventh switch device (T7) and the freewheeling diode (D9), and a second end of the inductor (L1) and the positive electrode of the freewheeling diode (D9) are used as two terminals for connection to an energy storage element.

In some embodiments, the energy storage element is any one of below: a rechargeable battery (E) or a capacitor arranged inside the motor driver, or an external power supply connected to the outside of the motor driver.

In some embodiments, a positive electrode of the rechargeable battery (E) is connected to the second end of the inductor (L1), and a negative electrode of the rechargeable battery (E) is connected to the positive electrode of the freewheeling diode (D9); and in a case that the motor connected to the motor driver (20) operates in a regeneration braking mode, regeneration energy generated during braking is stored in the rechargeable battery (E). In some embodiments, the first to seventh switch devices (T1, T2, T3, T4, T5, T6, and T7) each comprise a fully controlled power transistor and a diode, and a positive electrode and a negative electrode of the diode are respectively connected to an emitter and a collector of the fully controlled power transistor.

In some embodiments, the fully controlled power transistor is an insulated gate bipolar transistor (IGBT).

As another example, some embodiments include a motor driving system, comprising the motor driver as described herein and a motor, wherein the motor driver is configured to drive the motor; and in a case that the motor operates in a regeneration braking mode, regeneration energy generated during braking of the motor is stored in the rechargeable battery of the motor driver.

### BRIEF DESCRIPTION OF THE DRAWINGS

Referring to the descriptions of the embodiments of the present disclosure in combination with the accompanying drawings, the foregoing and other objectives, features, and advantages of the teachings herein may be more easily understood. Components in the accompanying drawings are merely used for demonstrating the principle of the present disclosure. In the accompanying drawings, the same or similar technical features or components may be represented by using the same or similar reference numerals. In the accompanying drawings:

FIG. 1 is a circuit topology diagram of a motor driver in the prior art;

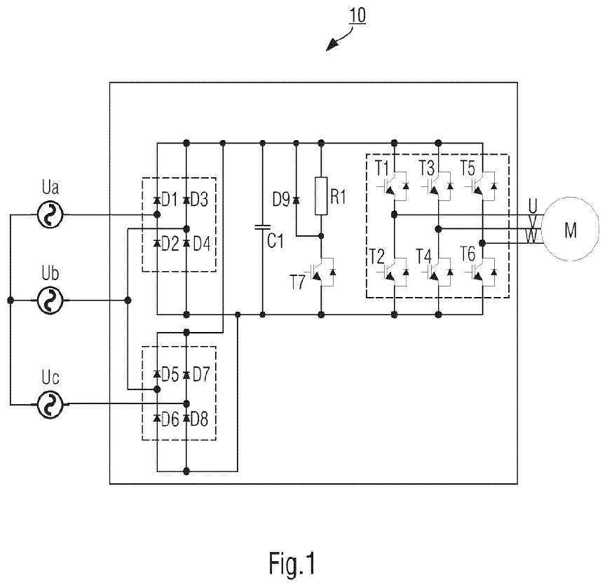

FIG. 2 is a circuit topology diagram of an example motor driver incorporating teachings of the present disclosure.

### REFERENCE NUMERALS

| | |
|---|---|
| 10, 20: Motor driver | Ua, Ub, and Uc: Three-phase |
| | grid |
| D1-D9: Diode | R1: resistor |
| T1-T7: First to seventh | 210: Rectifier circuit |
| switch device | |
| 220: DC link circuit | 230: Inverter circuit |
| M: Motor | 2101: First rectifier bridge |
| 2102: Second rectifier bridge | 2301, 2302, 2303: First to |
| | third DC/AC conversion branch |
| | circuit |
| L1: Inductor | E: Rechargeable battery |
| C1: Capacitor | |

### DETAILED DESCRIPTION

Some embodiments of the present disclosure include a motor driver. An input terminal of the motor driver is connected to a three-phase grid, and an output terminal of the motor driver is connected to a motor. The motor driver includes a rectifier circuit, a DC link circuit, and an inverter circuit. The rectifier circuit includes a first rectifier bridge and a second rectifier bridge. The inverter circuit includes a first DC/AC conversion branch circuit, a second DC/AC conversion branch circuit, and a third DC/AC conversion branch circuit arranged in parallel between a positive output terminal and a negative output terminal of the DC link circuit. The first DC/AC conversion branch circuit includes a first switch device and a second switch device, the second DC/AC conversion branch circuit includes a third switch device and a fourth switch device, and the third DC/AC conversion branch circuit includes a fifth switch device and a sixth switch device.

The DC link circuit is connected between the rectifier circuit and the inverter circuit. The DC link circuit includes a capacitor, a switch device, a freewheeling diode, and an inductor. A first end and a second end of the capacitor are respectively connected to a positive output terminal and a negative output terminal of the rectifier circuit. A collector of the seventh switch device is connected to the first end of the capacitor. An emitter of the seventh switch device is connected to a negative electrode of the freewheeling diode. A positive electrode of the freewheeling diode is connected to the second end of the capacitor. A first end of the inductor is connected to a midpoint between the seventh switch device and the freewheeling diode. A second end of the inductor and the positive electrode of the freewheeling diode are used as two terminals for connection to an energy storage element. In this way, overvoltage damage to the capacitor can be prevented.

In some embodiments, the energy storage element is any one of a rechargeable battery), a capacitor arranged inside the motor driver, or an external power supply connected to the outside of the motor driver. In this way, a proper energy storage element may be selected as required.

In some embodiments, a positive electrode of the rechargeable battery is connected to the second end of the inductor, and a negative electrode of the rechargeable battery is connected to the positive electrode of the freewheeling diode. In a case that the motor connected to the motor driver operates in a regeneration braking mode, regeneration energy generated during braking is stored in the rechargeable battery.

In this way, the regeneration energy generated during the braking may be stored in the rechargeable battery to effectively use the regeneration energy. In addition, for the driver requiring an external power supply as an auxiliary power supply and a motor brake hold power supply, the rechargeable battery may be directly used as the auxiliary power supply and the motor brake hold power supply.

In some embodiments, the first to seventh switch devices each include a fully controlled power transistor and a diode, and a positive electrode and a negative electrode of the diode are respectively connected to an emitter and a collector of the fully controlled power transistor.

In some embodiments, the fully controlled power transistor includes an insulated gate bipolar transistor (IGBT).

Some embodiments include a motor driving system, including the motor driver described above and a motor, and the motor driver is configured to drive the motor. In a case that the motor operates in a regeneration braking mode, regeneration energy generated during braking of the motor is stored in the rechargeable battery of the motor driver.

In the circuit topology of the motor driver, the inductor is added to the DC link circuit, so that a braking resistor frequently used in the prior art is removed. The braking resistor is usually large in size, generates a lot of heat, and requires high costs. Therefore, the technical solutions of the present disclosure has one or more of the following technical advantages:
1. The heat sink design of the system is promoted, and the impact of the braking resistor on other temperature sensing components can be eliminated.
2. The volume is reduced. In the circuit topology of the prior art, the braking resistor needs to dissipate the regeneration energy, and therefore requires a huge volume. Removing the resistor from the circuit topology of the present invention helps save the volume.
3. The rechargeable battery added to store the regeneration energy during the motor braking, which helps save the energy. In addition, the rechargeable battery may be directly used as the auxiliary power supply and the motor brake hold power supply of the motor driver.

Teachings of this present disclosure are discussed now with reference to exemplary implementations. It should be understood that discussion of the implementations is merely intended to make a person skilled in the art better understand and implement the subject described in this specification and is not intended to limit the protection scope of the claims, the applicability, or examples. Changes may be made to the functions and arrangements of the discussed elements without departing from the protection scope of the content of the present disclosure. Various processes or components may be omitted, replaced, or added in each example according to requirements. For example, the described methods may be performed according to a sequence different from the sequence described herein, and steps may be added, omitted, or combined. In addition, features described in some examples may also be combined in other examples.

As used in this specification, the term “include” and variants thereof represent open terms, and means “include but is not limited to”. The term “based on” represents “at least partially based on”. The terms “one embodiment” and “an embodiment” represent “at least one embodiment”. The term “another embodiment” represents “at least one another embodiment”. The terms “first”, “second”, and the like may represent different objects or the same object. Other definitions may be includes explicitly or implicitly in the following. Unless otherwise clearly specified, the definition of one term is consistent in the entire specification.

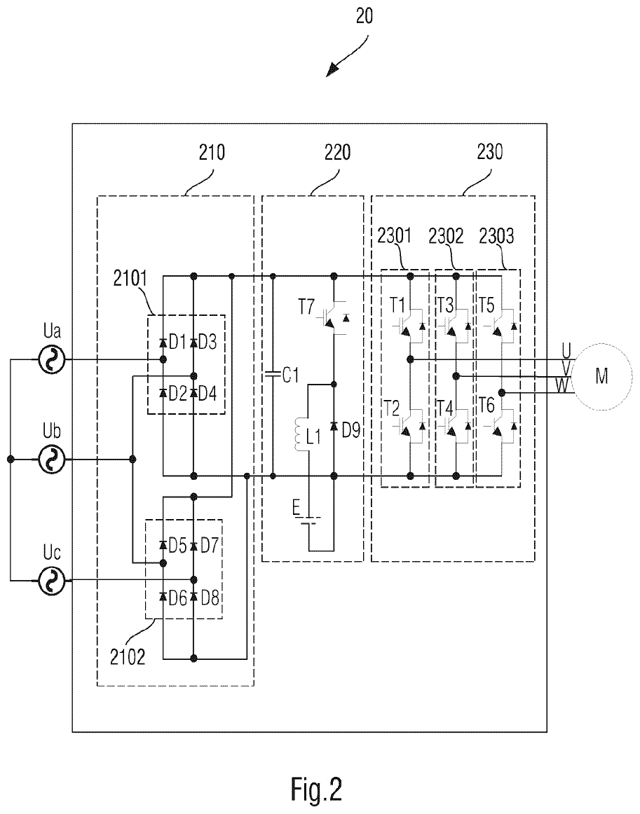

FIG. 2 is a circuit topology of an example motor driver 20 incorporating teachings of the present disclosure. As shown in FIG. 2, an input terminal of the motor driver 20 is connected to three phase Ua, Ub, and Uc of a three-phase grid, and an output terminal of the motor driver is connected to a motor M. The motor driver 20 includes a rectifier circuit 210, a DC link circuit 220, and an inverter circuit 230.

The rectifier circuit 210 includes a first rectifier bridge 2101 and a second rectifier bridge 2102. Specifically, the first rectifier bridge 2101 includes a first bridge arm and a second bridge arm. The first bridge arm and the second bridge arm are connected in parallel. The first bridge arm includes a first diode D1 and a second diode D2 connected in series, and the second bridge arm includes a third diode D3 and a fourth diode D4 connected in series. The second rectifier bridge 2102 includes a third bridge arm and a fourth bridge arm. The third bridge arm and the fourth bridge arm are connected in parallel. The third bridge arm includes a fifth diode D5 and a sixth diode D6 connected in series, and the fourth bridge arm includes a seventh diode D7 and an eighth diode D8 connected in series.

A phase-a input terminal of the three-phase grid is connected to a midpoint between the first diode D1 and the second diode D2 of the first bridge arm. A phase-b input terminal of the three-phase grid is connected to a midpoint between the third diode D3 and the fourth diode D4 of the second bridge arm and a midpoint between the fifth diode D5 and the sixth diode D6 of the third bridge arm. A phase-c output terminal of the three-phase grid is connected to a midpoint between the seventh diode D7 and the eighth diode D8 of the fourth bridge arm. A positive output terminal and a negative output terminal of the first rectifier bridge 2101 are respectively connected to a positive output terminal and a negative output terminal of the second rectifier bridge 2102.

In some embodiments, the three-phase grid and the rectifier circuit 210 may alternatively be connected in other manners, and are not limited to those shown in FIG. 2.

The circuit topology of the rectifier circuit 210 in FIG. 2 is a common circuit in the prior art. The rectifier circuit of the present disclosure may not be limited to that shown in FIG. 2 and may be other topologies. Details are not described herein.

The inverter circuit 230 is connected to the DC link circuit 220 and includes three DC/AC conversion branch circuits: a first DC/AC conversion branch circuit, a second DC/AC conversion branch circuit, and a third DC/AC conversion branch circuit, which are configured to convert a DC voltage outputted by the DC link circuit into an AC voltage.

Specifically, the inverter circuit 230 includes a first DC/AC conversion branch circuit 2301, a second DC/AC conversion branch circuit 2302, and a third DC/AC conversion branch circuit 2303 arranged in parallel between a positive output terminal and a negative output terminal of the DC link circuit 220. The first DC/AC conversion branch circuit 2301 includes two switch devices: a first switch device T1 and a second switch device T2. The second DC/AC conversion branch circuit 2302 includes two switch devices: a third switch device T3 and a fourth switch device T4. The third DC/AC conversion branch circuit 2303 includes two switch devices: a fifth switch device T5 and a sixth switch device T6.

The DC link circuit 220 is connected between the rectifier circuit 210 and the inverter circuit 230 for filtering the output voltage of the rectifier circuit. Specifically, as shown in FIG. 2, the DC link circuit 220 includes a capacitor C1, a seventh switch device T7, a freewheeling diode D9, an inductor L1, and a rechargeable battery E. A first end and a second end of the capacitor C1 are respectively connected to a positive output terminal and a negative output terminal of the rectifier circuit 210. A collector of the seventh switch device T7 is connected to the first end of the capacitor C1. An emitter of the seventh switch device T7 is connected to a negative electrode of the freewheeling diode D9. A positive electrode of the freewheeling diode D9 is connected to the second end of the capacitor. A first end of the inductor L1 is connected to a midpoint between the seventh switch device T7 and the freewheeling diode D9. A second end of the inductor L1 is connected to a positive electrode of the rechargeable battery E, and a negative electrode of the rechargeable battery E is connected to the positive electrode of the freewheeling diode D9.

In FIG. 2, the rechargeable battery E is connected between the inductor L1 and the freewheeling diode D9 as an energy storage element. It may be understood that a capacitor may also be used as the energy storage element.

In some embodiments, the motor driver does not include the energy storage element. The second end of the inductor L1 and the positive electrode of the freewheeling diode D9 form two terminals, which may be connected to an external energy storage element. For example, during operation of the motor driver, an external power supply is connected between the two terminals, that is, the second end of the inductor L1 and the positive electrode of the freewheeling diode D9.

As shown in FIG. 2, the first to the seventh switch devices each are composed of a fully controlled power transistor and a diode, and a positive electrode and a negative electrode of the diode are respectively connected to an emitter and a collector of the fully controlled power transistor. In other examples of the present disclosure, the single fully controlled power transistor may be composed of a plurality of fully controlled power transistors in parallel, series, or mixed connection. Similarly, the single diode may be composed of a plurality of diodes in parallel, series, or mixed connection. In the present disclosure, the fully controlled power transistor is, for example, an insulated gate bipolar transistor (IGBT). Those skilled in the art may understand that other types of power transistors may be used, which are not detailed herein.

When the motor operates in a regeneration braking mode, the seventh switch device T7, the freewheeling diode D9, and the inductor L1 in the motor driver of the present invention may be used as a buck converter. During g the motor braking, regeneration energy is applied to the capacitor of the DC link circuit, causing a rise of the DC voltage. If the voltage continuously rises and exceeds an allowable operating voltage, the DC capacitor may be damaged. In the circuit topology using the buck converter in the motor driver of the present invention, when the DC voltage is greater than a protection voltage, the switch device T7 is turned on, so that the circuit composed of the seventh switch device T7, the freewheeling diode D9, and the inductor L1 can reduce the DC voltage.

If a rechargeable battery E is connected between the inductor and the diode, the regeneration energy generated during the braking may be stored in the rechargeable battery E to effectively use the regeneration energy. In addition, for a low-voltage servo driver requiring an external power supply as an auxiliary power supply and a motor brake hold power supply, the rechargeable battery E may be directly used as the auxiliary power supply and the motor brake hold power supply.

A proper voltage may be selected for the rechargeable battery E as required, for example, a 24V rechargeable battery may be used.

A motor driving system is also shown in FIG. 2, comprising the motor driver 20 described above and a motor M, in which the motor driver 20 is configured to drive the motor M; and in a case that the motor M operates in a regeneration braking mode, regeneration energy generated during braking of the motor M is stored in the rechargeable battery E of the motor driver.

In the circuit topology of the motor driver of the present invention, the inductor is added to the DC link circuit, so that a braking resistor frequently used in the prior art is removed. The braking resistor is usually large in size, generates a lot of heat, and requires high costs. Therefore, the circuit topology of the motor driver of the present invention has one or more of the following technical advantages.
1. The heat sink design of the system is promoted, and the impact of the braking resistor on other temperature sensing components can be eliminated.
2. The volume is reduced. In the circuit topology of the prior art, the braking resistor needs to dissipate the regeneration energy, and therefore requires a huge volume. Removing the resistor from the circuit topology of the present invention helps save the volume.
3. The rechargeable battery added to store the regeneration energy during the motor braking, which helps save the energy. In addition, the rechargeable battery may be directly used as the auxiliary power supply and the motor brake hold power supply of the motor driver.

Exemplary embodiments are described above in combination with specific implementations illustrated in the accompanying drawings, but this does not represent all embodiments that may be implemented or fall within the protection scope of the claims. A term “exemplary” used in the entire specification means “used as an example, an instance, or an illustration”, and does not mean “preferred” or “superior” over other embodiments. To provide an understanding of the described technologies, the specific implementations include specific details. However, these technologies may be implemented without these specific details. In some instances, to avoid confusing the concept of the described embodiments, a well-known structure and apparatus are shown in a block diagram form.

The descriptions of the content of the present disclosure are provided to allow any person of ordinary skill in the art to implement or use the teachings of the present disclosure. For a person of ordinary skill in the art, various modifications on the content of the present disclosure are obvious. In addition, a general principle defined in this specification may be applied to other variants without departing from the protection scope of the content of the present disclosure. Therefore, the content of the present disclosure is not limited to the examples and designs described in this specification, but is consistent with the widest range conforming to the principle and novelty disclosed in this specification.

The foregoing descriptions are merely preferred embodiments of the present invention but are not intended to limit the present invention. Any modification, equivalent replacement, or improvement made within the spirit and principle of the teachings of the present disclosure shall fall within the protection scope of the present disclosure.

What is claimed is:

1. A motor driver comprising:
an input terminal connected to a three-phase grid;
an output terminal connected to a motor;
a rectifier circuit;
a DC link circuit; and
an inverter circuit;
wherein the rectifier circuit comprises a first rectifier bridge and a second rectifier bridge;
the inverter circuit comprises a first DC/AC conversion branch circuit, a second DC/AC conversion branch circuit, and a third DC/AC conversion branch circuit arranged in parallel between a positive output terminal and a negative output terminal of the DC link circuit;
the first DC/AC conversion branch circuit comprises a first switch device and a second switch device;
the second DC/AC conversion branch circuit comprises a third switch device and a fourth switch device;
the third DC/AC conversion branch circuit comprises a fifth switch device and a sixth switch device;
the DC link circuit is connected between the rectifier circuit and the inverter circuit;
the DC link circuit comprises a capacitor, a seventh switch device, a freewheeling diode, and an inductor;
a first end and a second end of the capacitor are respectively connected to a positive output terminal and a negative output terminal of the rectifier circuit;
a collector of the seventh switch device is connected to the first end of the capacitor;
an emitter of the seventh switch device is connected to a negative electrode of the freewheeling diode;
a positive electrode of the freewheeling diode is connected to the second end of the capacitor;
a first end of the inductor is connected to a midpoint between the seventh switch device and the freewheeling diode; and
a second end of the inductor and the positive electrode of the freewheeling diode are used as two terminals for connection to an energy storage element.

2. The motor driver according to claim 1, wherein the energy storage element comprises at least one element selected from the group consisting of: a rechargeable battery, a capacitor arranged inside the motor driver, and an external power supply connected to the outside of the motor driver.

3. The motor driver according to claim 1, wherein;
the energy storage element comprises rechargeable battery;
a positive electrode of the rechargeable battery is connected to the second end of the inductor and a negative electrode of the rechargeable battery is connected to the positive electrode of the freewheeling diode; and
when the motor connected to the motor driver operates in a regeneration braking mode, regeneration energy generated during braking is stored in the rechargeable battery.

4. The motor driver according to claim 1, wherein:
the first to seventh switch devices each comprise a fully controlled power transistor and a diode; and
a positive electrode and a negative electrode of the diode are respectively connected to an emitter and a collector of the fully controlled power transistor.

5. The motor driver according to claim 4, wherein the fully controlled power transistor comprises an insulated gate bipolar transistor.

6. A driving system comprising:
a motor; and
a motor driver to drive the motor, the motor driver comprising:
an input terminal connected to a three-phase grid;
an output terminal connected to a motor;
a rectifier circuit;
a DC link circuit; and
an inverter circuit;
wherein the rectifier circuit comprises a first rectifier bridge and a second rectifier bridge;
the inverter circuit comprises a first DC/AC conversion branch circuit, a second DC/AC conversion branch circuit, and a third DC/AC conversion branch circuit arranged in parallel between a positive output terminal and a negative output terminal of the DC link circuit;
the first DC/AC conversion branch circuit comprises a first switch device and a second switch device;
the second DC/AC conversion branch circuit comprises a third switch device and a fourth switch device;
the third DC/AC conversion branch circuit comprises a fifth switch device and a sixth switch device;
the DC link circuit is connected between the rectifier circuit and the inverter circuit;
the DC link circuit comprises a capacitor, a seventh switch device, a freewheeling diode, and an inductor;
first end and a second end of the capacitor are respectively connected to a positive output terminal and a negative output terminal of the rectifier circuit;
a collector of the seventh switch device is connected to the first end of the capacitor;
an emitter of the seventh switch device is connected to a negative electrode of the freewheeling diode;
a positive electrode of the freewheeling diode is connected to the second end of the capacitor;
a first end of the inductor is connected to a midpoint between the seventh switch device and the freewheeling diode; and
a second end of the inductor and the positive electrode of the freewheeling diode are used as two terminals for connection to an energy storage element; and
when the motor operates in a regeneration braking mode, regeneration energy generated during braking of the motor is stored in the rechargeable battery of the motor driver.
